(19) United States
(12) Patent Application Publication
(10) Pub. No.: US 2006/0155548 A1
(43) Pub. Date: Jul. 13, 2006

(54) In-vehicle chat system

(75) Inventor: Masaaki Ichihara, Susono-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/319,169

(22) Filed: Dec. 28, 2005

(30) Foreign Application Priority Data
Jan. 11, 2005 (JP) 2005-004361

(51) Int. Cl. G10L 21/00

(52) U.S. Cl. 704/275

(57) ABSTRACT

An in-vehicle chat system realizes chatting between passengers of more than three vehicles through a center facility having a speech recognition device. The center facility selects only one of a plurality of speech signals competing with each other in accordance with a predetermined selection criterion based on results of speech recognition performed on the speech signals and distributes the selected one of the speech signals to each of the vehicles. The speech signals are generated, within a fixed time period after a speech signal was distributed from one of the vehicles to each of the vehicles, by two or more of the other vehicles.

### BACKGROUND OF THE INVENTION

1. Field of the Invention

The present invention generally relates to chat systems and, more particularly, to an in-vehicle chat system that realizes chatting between passengers of more than three vehicles according to transmission and reception of audio signals via a center facility.

2. Description of the Related Art

Conventionally, there is known a technique, such as disclosed in Japanese Laid-Open Patent Application No. 2003-263193, which discriminates whether or not a speaker has been changed over during an operation of a speech-recognition system or whether or not setting of data with respect to a speaker at that time is appropriate. In order to achieve such a discrimination, a code-book independent from a speaker and a code-book dependent on at least one speaker are prepared, and the code-book independent from the speaker and the code-book dependent on the speaker are correlated with a speech signal or speech signal using vector quantification according to a speech-recognition system so as to determine identity of the speakers based on the result of correlation detection.

In the meantime, in recent years, with the progress in the speech-recognition technique and the radio communication technique, it has become possible to make communication (conversation) between vehicles of a plurality of users through, for example, a center facility. In such a case, the center facility transfers or distributes speech signals transmitted from one of the vehicles to other vehicles. According to such a speech transfer service, there are expected various kinds of services, such as realization of a conversation between two specified persons, realization of a conversation between specified three or more persons or realization of a conversation between unspecified persons.

In the conversation between specified two persons, what is necessary is just transmit mutually speech signals obtained from the vehicle of the other side. However, in the case of a conversation between more than three vehicles (more than three persons), if an inquiry is made by a user and there are responses simultaneously from other two users to the inquiry, there occurs a problem in that it is difficult to catch a speech since speeches of two persons are mixed with each other. In order to eliminate such a problem, it is considered to transmit two speeches with a fixed time difference. However, in such a case, there is a disadvantage or departure in that a conversation with good tempo cannot be made (that is, an advantage of chatting cannot be taken).

Moreover, in a case of conversation between many vehicles such as four or five vehicles, the above-mentioned problem tends to occur particularly since simultaneous multiple speeches tend to occur, and it is possible that a conversation cannot be made practically.

### SUMMARY OF THE INVENTION

It is a general object of the present invention to provide an improved and useful in-vehicle chat system in which the above-mentioned problems are eliminated.

A more specific object of the present invention is to provide an in-vehicle chat system which is capable of effectively realizing a conversation even between passengers of more than three vehicles.

In order to achieve the above-mentioned objects, there is provided according to one aspect of the present invention an in-vehicle chat system that realizes chatting between passengers of more than three vehicles through a center facility having a speech recognition device, wherein the center facility selects only one of a plurality of speech signals competing with each other in accordance with a predetermined selection criterion based on results of speech recognition performed on the speech signals and distributes the selected one of the speech signals to each of the vehicles, wherein the speech signals are generated, within a fixed time period after a speech signal was distributed from one of the vehicles to each of the vehicles, by two or more of the other vehicles.

In the in-vehicle chat system according to the present invention, the criterion of the selection may include a correlativity of each keyword contained in the speech signals competing with each other with respect to keywords contained in the speech signals distributed to the vehicles so that one of the speech signals competing with each other having a higher correlativity than other speech signals is selected by priority.

In the above-mentioned in-vehicle chat system, at least one of the speech signals competing with each other having the correlativity of a maximum value with respect to a speech signal distributed at an immediately preceding time may be excluded from candidates of the selection at the present time.

In the above-mentioned in-vehicle chat system, the correlativity may be derived based on an integrated value that is obtained by integrating correlation values between keywords by giving a weight to each of the correlation values in accordance with word class of the keywords.

In the above-mentioned in-vehicle chat system, the correlativity may be evaluated with respect to only keywords recognized by said speech recognition device at a recognition reliability level equal to or greater than a predetermined value.

In the above-mentioned in-vehicle chat system, the speech signals from the vehicles may contain vehicle identifications given to the vehicles, respectively, and at least one of the speech signals competing with each other having the vehicle identification that matches the vehicle identification contained in a speech signal distributed at an immediately preceding time may be excluded from candidates of the selection at the present time.

In the above-mentioned in-vehicle chat system, one of the speech signals competing with each other which is generated at an earliest time may be selected for two or more of the speech signals competing with each other having no significant difference in the correlativity.

In the above-mentioned in-vehicle chat system, at least one of the speech signals competing with each other containing a predetermined keyword may be selected absolutely.

Additionally, there is provided according to another aspect of the present invention a chat control method performed by a center facility having a speech recognition device for controlling an exchange of speech signals between vehicles through the center facility, the chat control method comprising: a distribution step of distributing a speech signal from one vehicle to two or more other vehicles; a reception step of receiving speech signals generated by the two or more other vehicles within a fixed time period after the distribution step; a correlation evaluation step of evaluating a correlativity between the speech signal distributed in said distribution step and each of the speech signals received in said reception step based on results of speech recognition by said speech recognition device; and a selection distribution step of distributing one of the speech signals received in said reception step to each of said vehicles, the one of the speech signals being selected in accordance with a result of evaluation by said correlation evaluation step.

Further, there is provided according to another aspect of the present invention a computer program product comprising a program storage device readable by a computer system tangibly embodying a program of instructions executed by the computer system to perform a chat control process for controlling an exchange of speech signals between vehicles, the chat control process comprising: distributing a speech signal from one vehicle to two or more other vehicles; receiving speech signals generated by the two or more other vehicles within a fixed time period after distributing the speech signal; evaluating a correlativity between the distributed speech signal and each of the received speech signals based on results of speech recognition; and distributing one of the received speech signals to each of the vehicles, the one of the received speech signals being selected in accordance with a result of the evaluation of the correlativity.

According to the present invention, an in-vehicle chat system, which can realize chatting between passengers of three or more vehicles, can be provided.

Other objects, features and advantages of the present invention will become more apparent from the following detailed description when read in conjunction with the accompanying drawings.

### BRIEF DESCRIPTION OF THE DRAWINGS

FIG. 1 is a system configuration diagram of an entire in-vehicle chat system according to an embodiment of the present invention;

FIG. 2 is a system configuration diagram showing a part of one of the vehicles shown in FIG. 1;

FIG. 3 is a system configuration diagram showing a part of a center facility shown in FIG. 1; and

FIG. 4 is a flowchart of a process performed by a chat control part and a speech recognition processing part according to the embodiment of the present invention.

### DETAILED DESCRIPTION OF THE PREFERRED EMBODIMENTS

A description will now be given, with reference to the drawings, of embodiments according to the present invention.

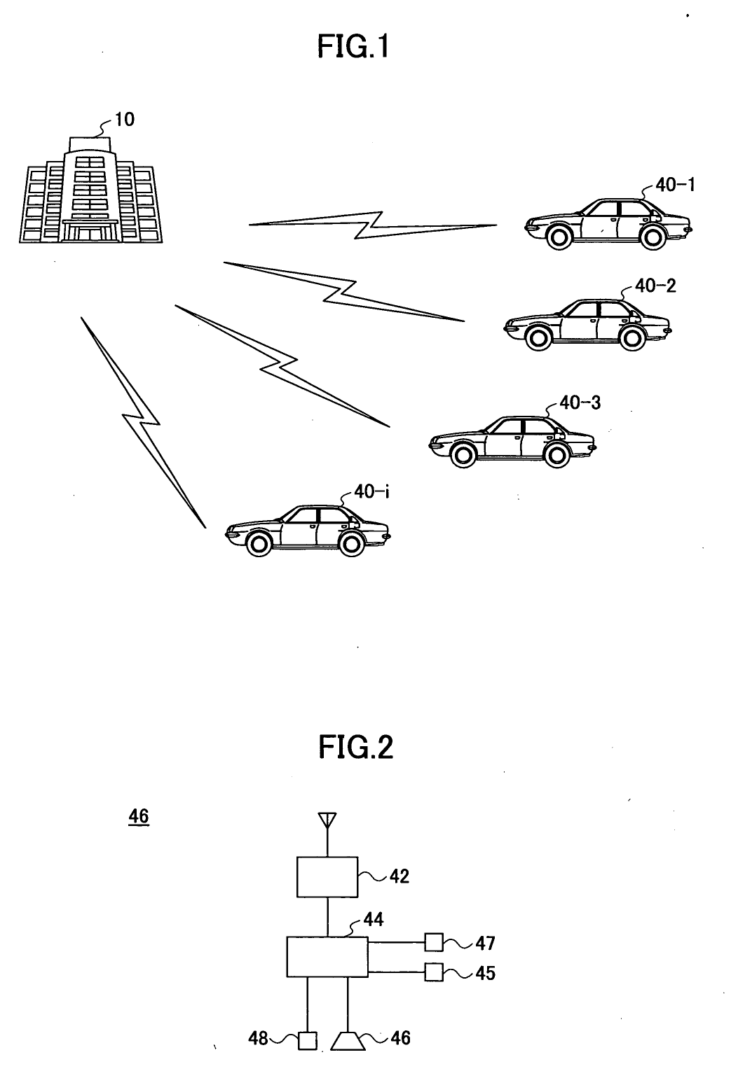

FIG. 1 is a system configuration diagram of an entire in-vehicle chat system according to an embodiment of the present invention. The in-vehicle chat system according to the present embodiment comprises a center facility 10 (hereinafter, referred to as center 10) and a plurality of vehicles 40-i (i=1, 2 . . . ). The center 10 and each of the vehicles 40-i are permitted to perform a bi-directional communication according to an appropriate radio communication technique. The center 10 is not always one facility, and may be a plurality of center facilities provided for respective regional service areas. In such a case, the center facilities may be connected so as to perform a bi-directional communication with each other so that chatting mentioned later can be realized between vehicles located at remote positions mutually.

FIG. 2 is a system configuration diagram showing a part of one of the vehicles shown in FIG. 1. Each of the vehicles 40-i comprises a communication module 42 that is capable of performing a bidirectional communication with the center 10, a master control device 44, a speaker 46 and a microphone 48.

The master control unit 44 applies predetermined processing, such as amplification processing, to a speech signal which is received from the center 10 through the communication module 42, and outputs the received speech signal through the speaker 46 installed at a predetermined position in a vehicle. Moreover, the master control unit 44 transmits speech signal (data of passenger's speech) input through the microphone 48 installed at a predetermined position in the vehicle to the center 10 through the communication module 42. In this case, the master control unit 44 includes a predetermined vehicle ID and time stamp in the speech signal (speech data) to be transmitted so that the center 10 can specify the vehicle and a transmitting time of a transmitting party.

The master control unit 44 transmits a chat start request signal to the center 10 through the communication module 42, when a chat switch 45 provided at a predetermined position of the vehicle is turned ON. Upon receipt of an affirmative response signal from the center 10, the master control unit 44 displays on a display 47 the fact that a chat start condition has been established. In this case, a current chat condition such as participating user names (vehicle IDs), a number of persons, current topic may be displayed on the display 47.

While the chat switch 45 is in the ON state, the master control unit 44 maintains the establishment of the connection condition and performs the above-mentioned transmission and reception process so as to realize chatting mentioned later.

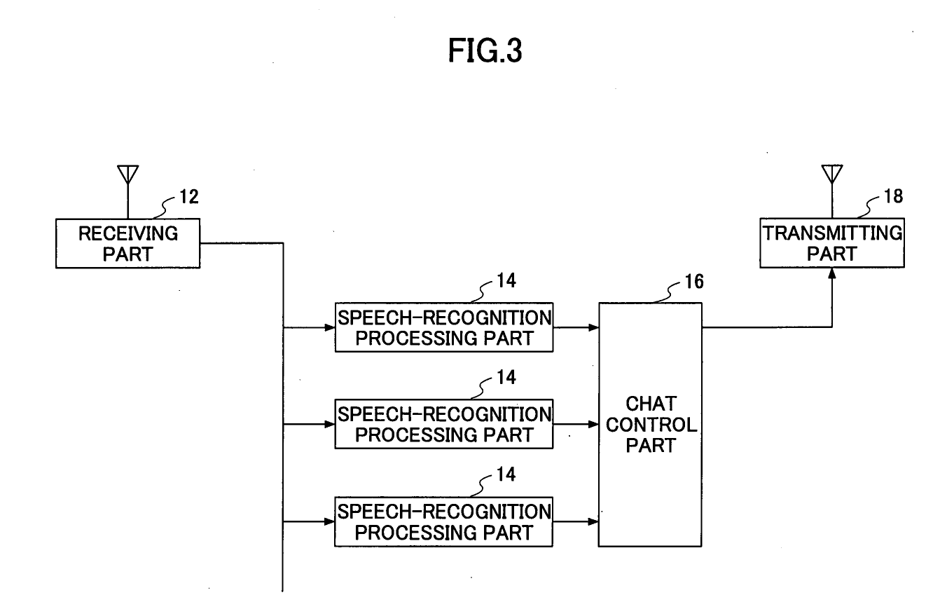

FIG. 3 is a system configuration diagram showing a part of the center 10. The center comprises a receiving part 12 that receives a speech signal (speech data) from the vehicles 40-i, speech recognition processing parts 14, a chat control part 16, and a transmitting part 18.

The receiving part 12 is provided with a function to receive a plurality of radio frequencies simultaneously according to time division or frequency division and demodulate the received radio frequencies so as to receive the speech signal transmitted from each of the vehicles 40-i. Hereinafter, for the sake of explanation, it is assumed that one speech signal corresponds to a speech of a series of words of one speaker as a unit. For example, if there was a speech of one user and thereafter speeches are made by the same user for a predetermined time period, the speeches are processed as different speech signals.

The speech signal received by the receiving part 12 is subjected to a predetermined process such as an amplification process, and a user name (vehicle ID) of the transmitting party is specified. Then, the speech signal received from one of the vehicles 40-i is supplied to one of the speech recognition processing parts 14.

In the speech recognition processing part 14, an amount of feature is extracted from the speech signal, and, subsequently, recognition candidates corresponding to the amount of feature concerned are determined through sound model processing/matching and language model processing/matching. In this case, the speech recognition processing part 14 computes a score which represent recognition accuracy, i.e., recognition reliability, with respect to each of the recognition candidates. For example, in a case that speech data from one of the vehicles 40-i is “I want to eat a hamburger, does anyone know a delicious shop in Toyota-city?”, the speech recognition processing part 14 discriminates “hamburger”, “want to eat”, “Toyota-city”, and “delicious” as keywords, and if the “hamburger” can be recognized as “Hamburg”, a low score is given as a comparatively low recognition reliability.

Each keyword extracted by the speech recognition processing part 14 is supplied to the chat control part 16 as a keyword string with a corresponding score. It should be noted that one keyword is produced for one speech signal.

The chat control part 16 transmits the speech signal received by the receiving part 12 to the predetermined vehicles 40-i through the transmitting part 18. For example, if three vehicles 40-1, 40-2 and 40-3 are participating chatting and when the above-mentioned speech signal is received from the vehicle 40-1, the center 10 transmits the speech signal to the vehicles 40-2 and 40-3 through the transmitting part 18. In this case, the speech signal transmitted to the vehicles 40-2 and 40-3 can be any signal, which is generated based on the speech signal transmitted by the vehicle 40-1. That is, the speech signal transmitted to the vehicles 40-2 and 40-3 may be a Pulse Coded Modulation (PCM) signal, which is substantially the same signal with the speech signal received from the vehicle 40-1, a speech signal which is produced by processing the speech signal received from the vehicle 40-1, or a speech signal which is produced by resynthesizing based on the result of recognition of the speech recognition processing parts 14.

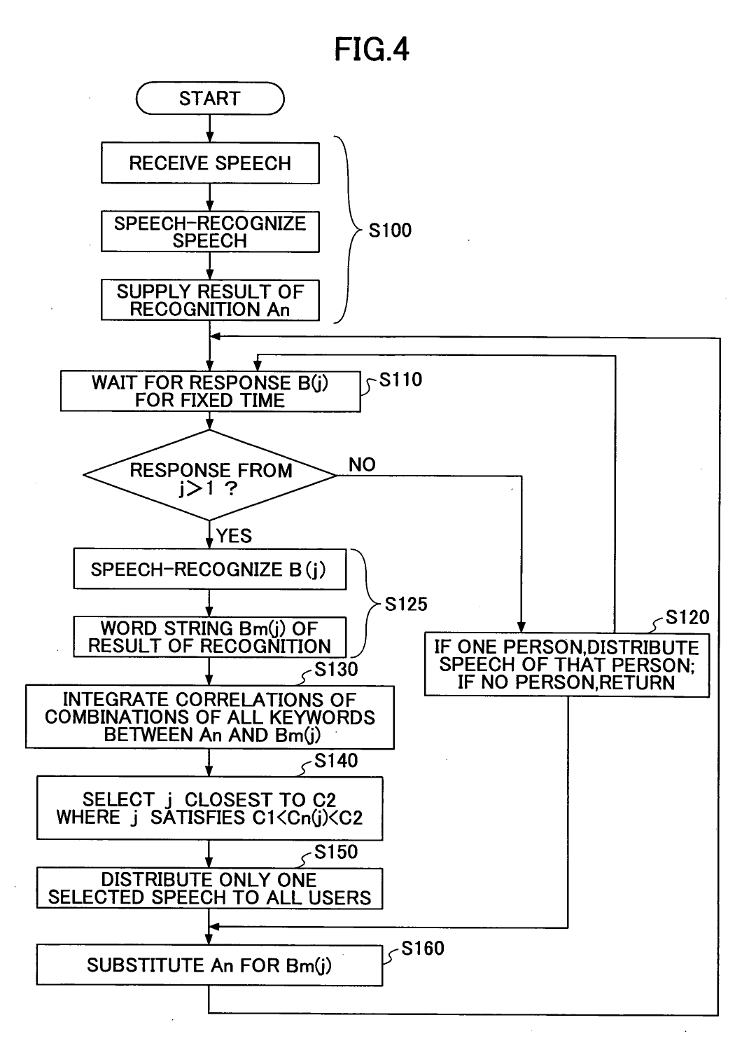

Moreover, if a plurality of speech signals are received simultaneously from the vehicle 40-1, the chat control part 16, as its discriminative configuration, transmits a appropriate one of the speech signals to each of the vehicles 40-i. For example, if, in the above-mentioned example, the speech signal from the vehicle 40-1 is transmitted to the vehicles 40-2 and 40-3 and thereafter a response speech signals of the vehicles 40-2 and 40-3 are generated simultaneously, the chat control part 16 transmits only the speech signal of the vehicle 40-2, for example, to the vehicles 40-1, 40-2 and 40-3 in accordance with predetermined selection criteria. Hereinafter, the discriminative structure of the chat control part 16 will be more specifically explained in detail with reference to FIG. 4.

FIG. 4 is a flowchart of a process performed by the chat control part 16 and the speech recognition processing part 14 according to the present embodiment.

First, in step S100, when a speech signal (speech data) is received by the receiving part 12 as mentioned above, a result of recognition (a keyword string) with respect to the speech signal concerned from the speech recognition processing part 14 is supplied to the chat control part 16. It should be noted that the speech signal concerned is assumed to be an initial speech (first speech in chatting) of a passenger of the vehicle 40-1. Accordingly, the speech signal from the vehicle 40-1 is transmitted to the vehicles 40-2 and 40-3 as a first speech. Hereinafter, the speech signal transmitted to the vehicles 40-i as mentioned above is referred to as “reference speech signal”.

In step S110, the chat control part 16 memorizes the keyword string from the speech recognition processing part 14 as a reference keyword string An, and monitors the receiving condition at the receiving part 12 for a fixed time period so as to wait for a response (reply) to the reference speech signal from other vehicles.

If no speech signal is received within the fixed time period, the process routine at this time is ended, and the routine returns to step S100.

If only one speech signal is received within the fixed time period (that is, only one vehicle sent a response), there is no need to perform a competition adjustment and, thus, the only one speech signal concerned is transmitted to each of the vehicles 40-i. In this case, the only one speech signal serves as the reference speech signal. Thus, the routine returns to step S100, and the chat control part 16 memorizes a keyword string corresponding to the only one speech signal as a reference keyword string An, and the process from step S110 is repeated so as to wait for a response to the only one speech signal concerned.

On the other hand, if a plurality of speech signals B(j) (j=a number of responding vehicles: j=1, 2 . . . ) are received within the fixed time period (that is, there are more than two responses), the speech recognition processing parts 14 extract, in step S125, results of recognition with respect to the speech signals B(j) (that is, keyword strings Bm(j) containing scores). Hereinafter, each of the plurality of speech signals B(j) competing with each other is referred to as a competing speech signal B(j).

It should be noted that, in the example shown in FIG. 3, the plurality of competing speech signals B(j) received by the receiving part 12 are processed concurrently by different speech recognition processing parts 14 so that keyword strings Bm(j) of the respective speech recognition processing parts 14 are sequentially supplied to the chat control part 16. The chat control part 16 is capable of identifying the transmitting party of each of the competing speech signals B(j) in accordance with the vehicle ID of each of the vehicles 40-i.

The chat control part 16 carries out a comparative evaluation of the keyword strings Bm(j) concerning the competing speech signals B(j) with respect to the reference keyword string An, respectively. The chat control part 16 computes a correlativity Cn(j) of each of the keyword strings Bm(j) with respect to a respective one of the reference keyword string An.

The correlativity Cn(j) may be extracted using a predetermined correlation value between the keywords. The correlation value is set to a generally high value for the words having the same meaning or synonymous words (for example, “stake-restaurant” and “steakhouse”). However, the correlation value may be set to a high value even for words having different meanings or non-synonymous words (for example, “steak” and “sizzling”). Data regarding the correlation is retained in a database (not shown in the figure) which the center 10 is accessible.

Specifically, the correlativity Cn(j) of the keyword strings Bm(j) with respect to the reference keyword string An can be computed as an integrated value (Cn(j)=(c1+c2+ . . . +cn) of correlation values (n'm correlation values) by deriving the correlation value of each keyword contained in the keyword strings Bm(j) with respect to each of the keywords contained in the reference keyword string An by: defining n keywords (a1, a2, . . . , an) contained in the keyword strings Bm(j) with respect to the reference keyword string An and m keywords (b1, b2, . . . , bm) contained in the keyword strings Bm(j); deriving the correlation value of each of m keywords contained in the keyword strings Bm(j) with respect to a1; deriving an integrated value cl of those correlation values (if c1 exceeds 1, c1=1); deriving a correlation value of each of the keywords (b1, b2, . . . , bm) with respect to a2; and deriving an integrated value c2 of those correlation values (if c2 exceeds 1, c2=1).

Alternatively, the correlativity Cn(j) may be computed as an integrated value (Cn(j)=(c1+c2+ . . . +cn/n) of maximum values (n maximum values) of the correlation values of the keywords contained in the keyword strings Bm(j) with respect to each of the keywords contained in the reference keyword string An by: deriving the correlation value of each of the keywords (b1, b2, . . . , bm) with respect to a1; setting a maximum value of those correlation values as c1; deriving a correlation value of each keywords (b1, b2, . . . , bm) with respect to a2; and deriving a maximum value c2 of those correlation values.

Moreover, the integrated values or the maximum values (c1, c2, . . . , cn) with respect to the keywords (a1, a2, . . . , an) may be weighted so that the maximum value of the correlativity Cn(j) is equal to 1. For example, using weighting coefficients (α1, α2, . . . , αn), the correlativity may be set as Cn(j)=(α1˜c1+α2˜c2+ . . . +αn˜cn)/n (where, αl+α2+ . . . +αn=1). In this case, the weighting coefficients (α1, α2, . . . , αn) assigned to the keywords (a1, a2, . . . , an) may be determined in accordance with word class of the keywords (a1, a2, . . . , an). For example, in order to select a response having rich contents, a relationship “a weighting coefficient regarding a noun>a weighting coefficient regarding a verb>a weighting coefficient regarding an adjective” may be established.

In any cases, the correlativity Cn(j) is preferably computed using only keywords having scores greater than a predetermined value. Thereby, the correlativity Cn(j) is computed by comparison between keywords having good recognition accuracy (recognition rate), which results in an improvement in the reliability of the correlativity Cn(j). From the same point of view, a weighting may be applied in accordance with values of the score.

It should be noted that although the above-mentioned methods of computing the correlativity Cn(j) computed the correlativity Cn(j) so that the relationship 0≦Cn(j)≦1 is satisfied, the present invention is not limited to that and also not limited to the above-mentioned methods. For example, consideration may be given not only correlativity with respect to an immediately preceding reference speech signal but also correlativity with respect to a plurality of reference speech signals preceding the immediately preceding reference speech signal.

After computing the correlativity Cn(j) as mentioned above, the chat control part 16 specifies and selects, in step S140, a correlativity Cn(j) within a predetermined range. That is, in the present embodiment, the correlativity Cn(j) satisfying C1<Cn(j)<C2 is specified using predetermined values C1 and C2. The chat control part 16 sends, in step S150, an only competing speech signal B(J) concerning the specified correlativity Cn(j) to each of the vehicles 40-i. For example, in the above-mentioned example, if there are responses from the vehicles 40-2 and 40-3 to the first speech (fist speech in chatting) of the vehicle 40-1, and if the correlativity Cn(2) concerning the vehicle 40-2 satisfies C1<Cn(2)<C2 and the correlativity Cn(3) concerning the vehicle 40-3 satisfies Cn(3)<C1, the speech signal concerning the response of the vehicle 40-3 is sent to each of the vehicles 40-1 to 40-3.

Here, the predetermined value C2 is set so as to not contain the maximum value 1. This is because a speech having a correlativity Cn(j) close to the maximum value 1 has a high-possibility of merely repeating the contents of the speech of the previous speaker and, in such a case, it contributes to a development of the future chatting to select other speeches by priority. Additionally, although the predetermined value C1 is provided to exclude extremely unrelated response, it may be a small value to some extent in consideration of necessity of changes in topics. It should be noted that the predetermined values C1 and C2 may be variable in accordance with a purpose of chatting or user's preference.

Alternatively, the chat control part 16 may simply select the competing speech signal B(j) concerning a large correlativity Cn(j) based on the magnitude correlation of the correlativity Cn(j). Also in such a case, the competing speech signal B(j) having a correlativity Cn(j) close to the maximum value 1 may be excluded from candidates of selection.

Moreover, when there is no correlativity Cn(j) within the predetermined range in the above-mentioned step S140, the chat control part 16 selects the competing speech signal B(j) concerning the largest correlativity Cn(j) by priority based on the magnitude correlation of the correlativity Cn(j), and sends, in step S150, the competing speech signal B(j) concerned to each of the vehicles 40-i through the transmitting part 18.

Moreover, when a plurality of correlativities Cn(j) exist within the predetermined range in step S140, the chat control part 16 sends, in step S150, the competing speech signal B(j) of which generation time is earliest to each of the vehicles 40-i through the transmitting part 18. It should be noted that although the generation time of each competing speech signal B(j) may be determined base on a time stamp that may be contained in each competing speech signal B(j), the generation time may be predicted, instead of determining it using the time stamp, based on a reception time of each competing speech signal B(j) by the center 10.

When the chat control part 16 selects only one competing speech signal B(j) from among a plurality of competing speech signals B(j), the keyword strings Bm(j) concerning the selected competing speech signal B(j) is substituted, in step S160, by the reference keyword string An, and the process from the above-mentioned step S110 is repeated. That is, the process from the step S110 is repeated by setting the competing speech signal as the reference speech signal.

Thus, according to the present embodiment, if a plurality of speech signals (competing speech signals) are generated simultaneously by a plurality of vehicles, only one of the competing speech signals is selected and sent. Accordingly, under such a condition, there is no situation happens in that a plurality of speech signals are simultaneously sent, which causes a problem that it is difficult to recognize who speaks what. Additionally, since the selected and sent competing speech signal is selected based on the correlation with the contents of the speech signal sent at previous time, the chatting does not go largely away from the topic. Thereby, an appropriate traffic control is carried out in chatting between a plurality of users, which enables continuation of the pleasant chatting.

It should be noted that although the competing speech signal B(j) corresponds to a plurality of speech signals that are received within the fixed time period after sending the reference speech signal in the present embodiment, the competing speech signal B(j) may be speech signals that compete with each other within the same time range. Additionally, although the generation time of each speech signal may be determined based on a time stamp contained in each speech signal, the generation time may be predicted, instead of using the time stamp, based on the reception time of each speech signal by the center 10.

A description will now be given of a selection criterion based on the above-mentioned correlativity and other selection criteria that may be used by priority or supplementarily.

As a first example, when there exists a specific keyword corresponding to a fixed phrase in the reference keyword string An of the reference speech signal, the competing speech signal having the keyword corresponding to the fixed phrase concerned may be selected by priority. For example, if a specific keyword “bye-bye” is contained in the reference keyword string An, a competing speech signal having a keyword string Bm such as “see you later” or “cheers” may be selected by priority.

As a second example, when a competing speech signal B(j) concerning the same vehicle with the reference speech signal is contained in the competing speech signals B(j) (that is, a speech signal from the same vehicle continues), the competing speech signal B(j) concerned is excluded from candidates of selection, and a competing speech signal B(j) from other vehicles may be given a priority. This is because there is less necessity to have chatting between passengers in the same vehicle through the center 10. However, it is well expected that passengers of other vehicles may want to listen the chatting, and, thus, the speech signals from the same vehicle may be selected if a correlativity of other competing speech signals greatly deviates from a predetermined range.

As a third example, when there exists a specific keyword designating one of other user names (vehicles) in the reference keyword string An of the reference speech signal, a competing speech signal concerning the designated user (vehicle) may be selected by priority. For example, when the reference speech signal contains a speech “How do you think, Mr. A?”, the competing speech signal from the vehicle concerning Mr. A may be selected by priority since the specific keyword “Mr. A (user name)” is contained in the reference keyword string An.

It should be noted that the above-mentioned chat control process according to the present invention may be performed by a computer system of the center 10. The computer system tangibly embodies a program of instruction, which is stored in a program storage device of the computer system, to perform the chat control process for controlling an exchange of speech signals between vehicles 40-i through the center 10. The chat control process distributes a speech signal from one vehicle to two or more other vehicles; receives speech signals generated by the two or more other vehicles within a fixed time period after distributing the speech signal; evaluates a correlativity between the distributed speech signal and each of the received speech signals based on results of speech recognition; and distributes one of the received speech signals to each of the vehicles, the one of the received speech signals being selected in accordance with a result of the evaluation of the correlativity.

It should be noted that the in-vehicle chat system according to the above-mentioned embodiments is applicable to various kinds of chat services such as one that realize chatting within a group consisting of more than three specific persons or one that realizes chatting between unspecified persons.

The present invention is not limited to the specifically disclosed embodiments, and variations and modifications may be made without departing from the scope of the present invention.

The present application is based on Japanese priority application No. 2005-004361, filed Jan. 11, 2005, the entire contents of which are hereby incorporated herein by reference.

What is claimed is:

1. An in-vehicle chat system that realizes chatting between passengers of more than three vehicles through a center facility having a speech recognition device, wherein the center facility selects only one of a plurality of speech signals competing with each other in accordance with a predetermined selection criterion based on results of speech recognition performed on the speech signals and distributes the selected one of the speech signals to each of the vehicles, wherein the speech signals are generated, within a fixed time period after a speech signal was distributed from one of the vehicles to each of the vehicles, by two or more of the other vehicles.

2. The in-vehicle chat system as claimed in claim 1, wherein the criterion of the selection includes a correlativity of each keyword contained in the speech signals competing with each other with respect to keywords contained in the speech signals distributed to the vehicles so that one of the speech signals competing with each other having a higher correlativity than other speech signals is selected by priority.

3. The in-vehicle chat system as claimed in claim 2, wherein at least one of the speech signals competing with each other having the correlativity of a maximum value with respect to a speech signal distributed at an immediately preceding time is excluded from candidates of the selection at the present time.

4. The in-vehicle chat system as claimed in claim 2, wherein the correlativity is derived based on an integrated value that is obtained by integrating correlation values between keywords by giving a weight to each of the correlation values in accordance with word class of the keywords.

5. The in-vehicle chat system as claimed in claim 2, wherein the correlativity is evaluated with respect to only keywords recognized by said speech recognition device at a recognition reliability level equal to or greater than a predetermined value.

6. The in-vehicle chat system as claimed in claim 2, wherein the speech signals from the vehicles contain vehicle identifications given to the vehicles, respectively, and at least one of the speech signals competing with each other having the vehicle identification that matches the vehicle identification contained in a speech signal distributed at an immediately preceding time is excluded from candidates of the selection at the present time.

7. The in-vehicle chat system as claimed in claim 2, wherein one of the speech signals competing with each other, which is generated at an earliest time, is selected for two or more of the speech signals competing with each other having no significant difference in the correlativity.

8. The in-vehicle chat system as claimed in claim 2, wherein at least one of the speech signals competing with each other containing a predetermined keyword is selected absolutely.

9. A chat control method performed by a center facility having a speech recognition device for controlling an exchange of speech signals between vehicles through the center facility, the chat control method comprising:
a distribution step of distributing a speech signal from one vehicle to two or more other vehicles;
a reception step of receiving speech signals generated by the two or more other vehicles within a fixed time period after the distribution step;
a correlation evaluation step of evaluating a correlativity between the speech signal distributed in said distribution step and each of the speech signals received in said reception step based on results of speech recognition by said speech recognition device; and
a selection distribution step of distributing one of the speech signals received in said reception step to each of said vehicles, the one of the speech signals being selected in accordance with a result of evaluation by said correlation evaluation step.

10. The chat control method as claimed in claim 9, wherein said selection distribution step selects only one of a plurality of speech signals competing with each other in accordance with a predetermined selection criterion that includes a correlativity of each keyword contained in the speech signals competing with each other with respect to keywords contained in the speech signals distributed to the vehicles so that one of the speech signals competing with each other having a higher correlativity than other speech signals is selected by priority.

11. The chat control method as claimed in claim 10, wherein said selection distribution step excludes at least one of the speech signals competing with each other having the correlativity of a maximum value with respect to a speech signal distributed at an immediately preceding time from candidates of the selection at the present time.

12. The chat control method as claimed in claim 10, wherein said selection distribution step derives the correlativity based on an integrated value that is obtained by integrating correlation values between keywords by giving a weight to each of the correlation values in accordance with word class of the keywords.

13. The chat control method as claimed in claim 10, wherein said correlation evaluation step evaluates the correlativity with respect to only keywords recognized by said speech recognition device at a recognition reliability level equal to or greater than a predetermined value.

14. The chat control method as claimed in claim 10, wherein the speech signals from the vehicles contain vehicle identifications given to the vehicles, respectively, and said selection and distribution step excludes at least one of the speech signals competing with each other having the vehicle identification that matches the vehicle identification contained in a speech signal distributed at an immediately preceding time from candidates of the selection at the present time.

15. The chat control method as claimed in claim 10, wherein said selection and distribution step selects one of the speech signals competing with each other, which is generated at an earliest time, for two or more of the speech signals competing with each other having no significant difference in the correlativity.

16. The chat control method as claimed in claim 10, wherein said selection and distribution step selects absolutely at least one of the speech signals competing with each other containing a predetermined keyword.

17. A computer program product comprising a program storage device readable by a computer system tangibly embodying a program of instructions executed by the computer system to perform a chat control process for controlling an exchange of speech signals between vehicles, the chat control process comprising:
distributing a speech signal from one vehicle to two or more other vehicles;
receiving speech signals generated by the two or more other vehicles within a fixed time period after distributing the speech signal;
evaluating a correlativity between the distributed speech signal and each of the received speech signals based on results of speech recognition; and
distributing one of the received speech signals to each of said vehicles, the one of the received speech signals being selected in accordance with a result of the evaluation of the correlativity.
